(19) United States
(12) Patent Application Publication
(10) Pub. No.: US 2025/0304836 A1
(43) Pub. Date: Oct. 2, 2025

(54) DURABLE PRINTABLE LABEL FILM

(71) Applicant: TORAY PLASTICS (AMERICA), INC., North Kingstown, RI (US)

(72) Inventors: Tracy PAOLILLI, North Kingstown, RI (US); Joshua CLOUTIER, North Kingstown, RI (US); Yu ABE, North Kingstown, RI (US)

(21) Appl. No.: 18/618,321

(22) Filed: Mar. 27, 2024

(51) Int. Cl. C09J 7/50; B32B 27/08; B32B 27/32; B32B 27/36; C09J 7/24; C09J 7/25; C09J 7/30

(52) U.S. Cl. CPC C09J 7/50; B32B 27/08; B32B 27/32; B32B 27/36; C09J 7/243; C09J 7/255; C09J 7/30; B32B 2250/02; B32B 2250/24; B32B 2255/10; B32B 2255/24; B32B 2307/414; B32B 2307/518; B32B 2307/704; B32B 2307/75; B32B 2519/00; C09J 2203/334; C09J 2423/00; C09J 2423/106; C09J 2467/006; C09J 2475/003

(57) ABSTRACT

An embodiment of the invention relates to a water-based print-receptive coating comprising a polyurethane. The print-receptive coating contains water, a binder and a crosslinker. The print receptive coating is in-line coated onto a print receptive skin of a polymeric substrate film at a stretch rate of 1-10 times in the transverse direction and is print-receptive to solvent, waterborne and UV/LED-curable inks. The print-receptive coated film has a haze change, measured according to ASTM D1003, before exposure to boiling water for 10 minutes and after exposure to boiling water for 10 minutes, of 3% or less

### CROSS REFERENCE TO RELATED APPLICATION(S)

This application is related to Ser. No. 17/889,765, filed on Aug. 17, 2022, titled as “DURABLE PRINTABLE LABEL FILM”, which is incorporated by reference in its entirety.

### FIELD OF THE INVENTION

The present disclosure relates to a water-based print-receptive coating in a film. In particular, the present disclosure relates to polyurethane containing water-based print-receptive coating in a film.

### BACKGROUND OF INVENTION

Print-receptive coatings are a necessary part of the process when it comes to digital printing on flexible packaging. Print-receptive coatings are needed to enable adhesion between ink and an adhesive-promoting polymeric layer during inkjet printing, forming a strong linkage between the two. The print-receptive layer also has an important role in controlling how the ink interacts with the substrate surface once the jetted drop of ink lands on it.

A primer controls the dot size of the ink while helping to anchor and hold ink onto the surface of the substrate to maximize color. In this way primers can reduce the amount of ink needed to get the desired color density, maximizing the optimal use of ink while enabling more photo-quality for the graphics.

From a packaging manufacturer's standpoint, print-receptive coatings and primers help to improve rub resistance, which allows more packaging to be printed and stacked on an assembly line to maximize productivity. Primers provide key benefits for product quality and for manufacturing productivity by providing a better surface for ink adhesion and drying.

Primers should be as robust as possible to work across a broad variety of applications and substrates, such as but not limited to: biaxially oriented polypropylene (BOPP) film substrates, biaxially oriented polyethylene terephthalate (BOPET) or other polyester film substrates. In most cases, manufacturers would like to use the same print-receptive coatings in their printers. However, the number of different types of film makes it difficult to make a print-receptive coating which works on all substrates. Normally, a primer will be developed for a specific group or type of polymeric films.

Application method is another consideration because print-receptive coatings can be applied in-line and off-line via flexo/gravure coating rolls. Packaging facilities print for a variety of customers who require a uniform look and feel for their packaging regardless of how it's printed. The film substrate must maintain the consistent level of gloss & haze whether printed digitally or via analog process.

Primers must also be formulated for different inks. Primers enable faster drying through absorption of the ink into the primer layer. Absorbent substrates have different challenges—drying alone isn't enough—absorption needs to be controlled to keep ink from wicking. Wicking is an undesirable trait where ink is absorbed without constraint resulting in vein-like striations in dense print areas.

From an economic perspective there is a need for a primer that can be coated in-line and printed upon regardless of ink type.

Although biaxially oriented polypropylene film and acrylic coating are each optically clear by themselves, the combination of a biaxially oriented polypropylene (BOPP) film coated with an acrylic coating material can have adverse optical properties. For example, the acrylic coating layer can exhibit excessive cracking as a result of the transverse direction stretching forces that an in-line coating process exposes the acrylic to vs. an off-line coating process that does not expose the acrylic to any stretching forces.

BOPP film is stretched in both machine and transverse directions, producing molecular chain orientation in two directions. BOPP film is produced by a tenter frame process, in which a thick extruded sheet is heated to its softening point (not to the melting point) and is mechanically stretched by 300-400%. Stretching in the tenter frame process is usually 4.5:1 in the machine direction and 8.0:1.0 in the transverse direction, although these ratios are fully adjustable.

It is a widely used process and a glossy, transparent film is produced. What has been discovered is when these films are coated with a polyurethane-modified coating after the machine direction & before the transverse direction (i.e. an in-line coating process) is that not only does the coating provide increased toughness, increased stiffness, enhanced clarity, improved solvent resistance, improved adhesion, and clarity through boiling and sterilization processes, it also provides improved ink adhesion for numerous ink types, such as: waterborne, solvent and UV/LED-curable inks.

One problem with the polyurethane-modified coated polypropylene films is the adhesion between the respective layers of polyurethane material and the polypropylene layer. In general, biaxially oriented polypropylene film has a highly crystalized surface that makes the polypropylene difficult to adhere with such polyurethane-modified coating layers. To overcome this drawback, an adhesion layer is used between the polypropylene and polyurethane polymer layers to improve adhesion.

AU2003214999A1: This invention relates to a topcoat composition comprising i: a mixture of A) at least one polyurethane and B) at least one durability improving polymer; ii: a mixture of two or more acrylic urethanes; or iii: a combination of i and ii. The invention also relates to ink receptive sheets comprising a substrate containing a topcoat derived from the topcoat compositions. The topcoat compositions of the present invention provide a flexible and durable substrate that allows printing with solvent-based inkjet inks used with non-vented printers and UV inkjet inks. This invention is strictly used on off-line coater.

EP365921B1 This invention relates to articles having a printed surface as well as flexible coating and film compositions that are printable in combination with exhibiting stain resistance. The composition comprises a hard component having an elongation of less than about 150%, a soft component having an elongation of greater than about 200%, and a cross-linking agent. The hard component preferably comprises a thermoplastic polyurethane, acrylic polymer, polymeric polyol, or mixture thereof. The soft component preferably comprises a thermoplastic urethane, polymeric polyol, or mixture thereof; whereas the cross-linking agent is preferably an isocyanate with dried coating thicknesses of 5-125 gsm. The application techniques are strictly off-line coated.

U.S. Pat. No. 1,117,439B2 describes various aqueous coating formulations. The compositions include one or more UV curable polyurethane dispersions, and optionally one or more of the following: non-UV curable acrylic polymers, a polyester dispersion, a non-UV curable polyurethane dispersion, and one or more additives. The compositions can be used to form topcoats that exhibit good resistance to scratches and solvents, and improved ink adhesion and image quality. In general, all the ingredients used in the preparation of the barrier and bonding layer compositions were formed into solvent solutions. Their invention utilizes an off-line coating process.

SUMMARY OF INVENTION

In an embodiment, in the present invention in-line coating process is polyurethane-based only. The transverse orientation from the in-line process improves the adhesion of the print-receptive coating to the BOPP substrate and improves ink adhesion for various inks, such as water-based, solvent-based & UV-curable inks.

In an embodiment, present invention using significantly low dried coating thicknesses of 0.2-1.0 gsm. It is water-based and is coated on an in-line coater and the coating is transversely stretched with the film.

In an embodiment, present invention coating is strictly water-based and applied with an in-line coater which provides different properties than that obtained by an off-line process.

In an embodiment, a film comprising a base layer comprising a biaxially oriented polypropylene (BOPP) or Polyester film and an in-line primer coating layer comprising a polyurethane and a crosslinker; wherein the film has a haze change before exposure to boiling water for 10 minutes and after exposure to boiling water for 10 minutes 3% or less, measured according to ASTM D1003, wherein the in-line primer coating layer is substantially free of an acrylic coating material.

In an embodiment, the crosslinker comprises carbodiimide and/or melamine.

In an embodiment, the in-line primer coating layer further comprises an anti-block agent.

In an embodiment, thickness of the in-line primer coating layer is in range of about 0.1 GSM to about 2.5 GSM.

In an embodiment, the in-line primer coating layer further comprises an adhesion promoter.

In an embodiment, the in-line primer coating layer further comprises a coalescing agent

In an embodiment, the in-line primer coating layer comprises a crosslinker catalyst.

In an embodiment, the base layer comprises a print receptive layer, a core layer, and an adhesive receptive layer.

In an embodiment, the core layer comprises polypropylene.

In an embodiment, polypropylene has crystallinity in a range of about 90-99% isotactic index.

In an embodiment, adhesive receptive layer comprises a first component for wettability of a coating adhesive and a second component to form an affinity with the polypropylene of the core layer. In an embodiment, first component and the second component are same. In an embodiment, first component comprises MAH-g-PP.

In an embodiment, the film further comprises a barrier layer comprising maleic anhydride and a polyolefin.

In an embodiment, an adhesive layer is between the in-liner primer coating layer and a core layer.

In an embodiment, the adhesive layer comprises maleic anhydride and a polyolefin.

In an embodiment, the print receptive layer comprises maleic anhydride grafted polypropylene (MAH-g-PP), HOPP, or a copolymer polypropylene (COPP).

In an embodiment, the core layer comprises an isotactic polypropylene and a crystalline polypropylene.

In an embodiment, the crystalline polypropylene comprises about 94% isotactic index or more.

In an embodiment, the adhesive receptive layer comprises a copolymer polypropylene (COPP) and HOPP.

In an embodiment, the COPP comprises about 4 wt % by of ethylene under an isotactic polypropylene domain.

In an embodiment, the COPP has a surface energy increase by about 2 dyne level by a corona treatment.

In an embodiment, the base layer comprises about 2% to about 4% by weight of the print receptive layer, about 92% to about 96% by weight of the core layer, and about 2% to about 4% by weight of the adhesive receptive layer, wherein all weights are based on a total weight of the base layer.

In an embodiment, the substantially free acrylic coating material comprises less than 5% of the acrylic coating material.

### BRIEF DESCRIPTION OF THE FIGURES

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1 illustrates an exemplary arrangement of different layers in a polymeric film.

FIG. 2 illustrates the second exemplary arrangement of different layers in a polymeric film.

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more”. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, two or more elements are “integral” if they are comprised of the same piece of material. As defined herein, two or more elements are “non-integral” if each is comprised of a different piece of material.

As defined herein, “approximately” or “about” can, in some embodiments, mean within plus or minus ten percent of the stated value. In other embodiments, “approximately” or “about” can mean within plus or minus five percent of the stated value. In further embodiments, “approximately” can mean within plus or minus three percent of the stated value. In yet other embodiments, “approximately” or “about” can mean within plus or minus one percent of the stated value.

The numeric values such as amount, weight, concentration as mentioned in some embodiments, are intended to include approximate variation of the mentioned value to the practical extent possible. For example: 20 could include approximate variation of 20±2, whereas value 0 can include only possible variation of less than 1.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

As used herein, the terms “on”, “applied on/over”, “formed on/over”, “deposited on/over”, “overlay” and “provided on/over” mean formed, deposited, or provided on but not necessarily in contact with the surface. For example, a coating layer “formed over” a substrate does not preclude the presence of one or more other coating layers of the same or different composition located between the formed coating layer and the substrate. It is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

The following terms and phrases, unless otherwise indicated, shall be understood to have the following meanings.

“Polymer” is a macromolecule compound prepared by polymerizing monomers of the same or different type. Polymers include homopolymers, random copolymers, block copolymers terpolymers, tetrapolymer, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on. “Random copolymer” is defined as a polymer in which the comonomers are located randomly in the polymer molecular structure.

In an embodiment, polymers could include additional additives.

Term, “Uniaxially oriented film” is broadly defined as the film is stretched only in a first or second technical direction.

Term, “Biaxially oriented film” is a film that is stretched in both machine and transverse directions, producing molecular chain orientation sequentially or simultaneously in two directions. Biaxial orientation occurs when a uniaxially oriented film is stretched in a second technical direction transverse to the first technical direction. Biaxial orientation can be achieved by stretching the film in both directions, either sequentially or simultaneously. For sequential biaxial orientation, the first technical direction stretching is completed before stretching in the second technical direction. In simultaneous biaxial orientation, both first and second direction stretching occur at or near the same time.

Terms “orientation”, “orienting”, “oriented”, and the like are used occasionally, whether or not accompanied by alignment of polymeric structural elements, and are meant to be interchangeable with corresponding terms, “stretch”, “stretching”, “stretched” and etc.

Term, “In-line” coating is defined as a coating process, wherein the coating on the film is applied before the orientation in transverse direction.

Term, “Off-line” coating is defined as a coating method, wherein the base layer film is formed completely (including any orientation steps) and then an ink print primer coating solution is applied to the completed base layer. Adhesive layers may be added to the core layer to complete base layer formation in the first stage of the off-line method. In the off-line method the printable label coating solution can be applied to a uniaxially stretched base layer, but typically the base layer is biaxially stretched. Commonly, although not necessarily, the steps of base layer film forming, and primer layer solution coating are performed discontinuously from each other. That is, the base layer film can be produced, stretched and held in storage for coating at a subsequent time and usually at a different location.

In an embodiment, after production of the base layer, it is subjected to coating with the printable label liquid solution. Various solution coating methods well known in the art may be used. Representative examples include dip, spray, paint, doctor, gravure and Mayer (sometimes referred to as “Meyer”) rod type techniques. Preferably a Mayer rod coater with a No. 2 or No. 4 Mayer rod can be used. It is also sometimes helpful to ion discharge-treat the coating receiving side of the base layer prior to coating to improve adhesion of the coating layer and/or to wet-out (i.e., uniformly spread) the coating liquid onto the base layer surface. Such discharge-treatment methods are well-known in the art as corona treatment, flame treatment, plasma treatment, atmospheric plasma treatment, or corona treatment in a controlled atmosphere.

After coating the base layer surface with the printable liquid coating solution, a solidified printable layer is formed by heating the wet-coated base layer. The heat both dries the printable coating layer by evaporating volatile liquid components and causes reactive components to crosslink the residual polymer of the liquid solution.

Off-line coating separate from base layer film formation can be carried out in a continuous film coating operation.

Term “crosslinker” or “cross-linker” or similar is defined as a compound that can include one or more polymerizable groups, can join monomer chains together, and permit the formation of films. It means a chemical compound containing at least one chemical group (e.g., hydroxyl, carboxyl, vinyl, or blocked isocyanate) capable of undergoing inter-or intra-molecular chemical reaction to form a cross-link. In certain aspects and embodiments, cross-linkers contain at least two such groups on average. Non-limiting illustrative examples of cross-linkers for cyclic ether resins include but are not limited to: lower alkylated melamine; carbodiimide; lower alkylated and imino mixed ether melamine; carbolower alkylated ureas; formaldehyde-free modified ureas; benzoguanamine; aminoplast polymers; anhydrides; diacids; and cross-linkable polymers that are substituted by glycoluril, an amine, a hydroxyl group, a vinyl group or an isocyanate group.

In an embodiment, cross-linkers are selected from carbodiimide, melamine or aziridine.

Term, “polyurethane” often abbreviated PUR and PU) refers to a class of polymers composed of organic units joined by carbamate (urethane) links. Chemically, polyurethanes are distinguished by their characteristic carbamate (—NH—CO—O—) linkages and are generally prepared by reacting a multifunctional isocyanate with a multifunctional diol, or more generally polyol, with the presence of a catalyst. There are two general types of polyurethanes, thermoset and thermoplastic. Thermoset polyurethanes are highly crosslinked by covalent bonds. Thermoplastic polyurethanes are characterized by linear polymeric chains having self-ordering block structures. These polyurethanes are generally uncrosslinked but can also be lightly crosslinked. The block structures of a thermoplastic polyurethane generally include alternating “hard” and “soft” segments covalently bonded to each other end-to-end. The hard segments aggregate to form crystalline regions that act like physical crosslinks at ambient temperatures but convert to a molten state upon heating. As a result, thermoplastic polyurethanes are well suited for thermoforming onto three dimensional articles and can be easily reprocessed.

Suitable polyurethane dispersions are commercially available from NeoResins under the designation NeoRez® R-600, or NeoRez® FP-967-D. Other suitable aliphatic polyurethane dispersions include NeoRez® R-610 (available from NeoResins), NeoRez® R-605 XP (available from DSM) and Kamthane S-1801 (available from Kamsons).

Still other suitable aliphatic polyurethane dispersions are commercially available from BASF under the designations Epotal® FLX 3621 (an amorphous polyurethane dispersion), Epotal® P 350 (an elastomeric polyether polyurethane dispersion), Emuldur® 381 A (an elastomeric polyester polyurethane dispersion), Luphen® D 207 (an elastomeric polyester-polyurethane dispersion), Luphen® D 259 (an elastomeric polyether-polyurethane dispersion), and Luphen® 585 (an elastomeric polyester-polyurethane dispersion); from Lubrizol under the designations Sancure® 2170 and 2175; and from Baxenden Chemicals under the designations Witcobond® 781 and 373-04.

Polyurethane could be a polyester-based polyurethane, a polycarbonate-based polyurethane or a combination of both.

Term, “antiblock” or “anti-block” refers to agents that reduce frictional forces between the film layers in contact, thereby improving the handling and conversion of the film. Antiblock agents can be broadly separated into organic and inorganic additives. In one embodiment, the antiblock agent is an organic antiblock-agent. In another embodiment, the anti-block agent is selected from inorganic additives.

It is selected from amorphous silicas, aluminosilicates, sodium calcium aluminum silicates, crosslinked silicone polymers, and polymethylmethacrylates.

Term, “adhesion promoter” is defined as refer to a component that, when included in a composition, promotes adhesion of the composition to a substrate.

In an embodiment, adhesion promoter is selected from one type of the monomeric units of the random copolymer comprises halogen and/or a pendant organic group having six or more carbon atoms and another type of monomeric units of the random copolymer comprises an active hydrogen-containing functional group.

A “non-reactive adhesion promoter” is a component of a composition that does not react with other components of the composition and which promotes adhesion of the composition or a coating layer formed therefrom to a substrate, e.g. a polyolefin-based substrate suitable components for non-reactive adhesion promoter (b)(i) include chlorinated polyolefins (CPOs), such as those available commercially from Nippon Paper Chemicals under the trade designations SUPERCHLON® E-723, E-673, and/or E-503. Alternative components for non-reactive adhesion promoter (b)(i) include non-chlorinated polyolefins, such as those commercially available from Eastman under the trade name ADVANTIS® 510W and/or those available commercially from Nippon Paper Chemicals under the trade names AUROREN® AE 201 and/or AE-301.

Term, “coalescing agent” or “coalescent” causes a polymer powder uniformly distributed in a finely divided state to coalesce and form a uniform film or coating within a short time after it came in contact with the coalescent.

Some examples of coalescent includes glycol ethers or ether alcohols, mono alkyl ether alcohols, etc. including diethylene glycol C1-6 mono- or dialkyl ether, diethylene glycol ethyl ether, diethylene glycol butyl ether, dipropylene glycol methyl ether, tripropylene glycol ethyl ether, propylene glycol ethyl ether, glycol ether, triethylene glycol ethyl ether, etc. Selected other coalescents can include TEXANOL™ (isobutyrate), benzyl alcohol and 3-methoxybutanol-1. Examples of low volatility fugitive coalescents include the monomethyl, monoethyl and monobutyl ethers of diethylene glycol, triethylene glycol, dipropylene glycol and tripropylene glycol and also benzyl alcohol, isophorone, polytrimethylene ether glycol having a Mn (number average molecular weight) in a range of from 100 to 490 and methoxybutanol.

“Acid catalyst” are the compounds that function as sources for the protons in a reaction. An acid catalyst is a strong acid, for example an acid having a pKa of no greater than −1.74. Alternatively, the acid catalyst may be a weak acid, for example an acid having a pKa of greater than −1.74. The acid catalyst may be an organic acid or an inorganic acid.

The acid catalyst may be selected from organic sulfonic acid, sulphuric acid and ammonium nitrate. Preferably the acid is an organic sulfonic acid, such as p-toluenesulfonic acid or dodecylbenzenesulfonic acid (DDBSA). Suitable p-toluenesulfonic acids for use in the present invention may be selected from those available from Cytec under the trade name “CYCAT®”. Suitable dodecylbenzenesulfonic acids for use in the present invention may be selected from those available from King Industries, Inc. under the trade name “Nacure”, such as Nacure 5076 or Nacure 5925. Nacure 5076 is a strong acid catalyst based on DDBSA, generally supplied at 70% active in Isopropanol. Nacure 5925 is an amine neutralized DDBSA catalyst.

Term, “acrylic” or “acrylic polymer” used as the water dispersible polymer include (co)polymers obtained by the free-radical addition polymerization of at least one (meth)acrylic type monomer and optionally of other vinylic or allylic compounds. The acrylic polymers provide a smooth film-formed and ink-receptive surface. Suitable acrylic polymers are homopolymers of (meth)acrylic acid or alkyl (meth)acrylate, the alkyl radical having 1 to 10 carbon atom, or copolymers of two or more of the said (meth)acrylic type monomer and optionally of other vinylic or allylic compounds.

Term, “Biaxially oriented film” is a film that is stretched in both machine and transverse directions, producing molecular chain orientation sequentially or simultaneously in two directions. A biaxially oriented film has much higher tearing strength in machine direction in comparison with a blown film which is mainly oriented in machine direction. In addition, a blown film can also have high heat shrinkage in machine direction.

Term, “Crystallinity” refers to the degree of highly organized order structure excluding the fraction of amorphous phases in a resin.

Term, “Maleic anhydride-grafted polypropylene (MAH-g-PP)” is a compatibilizer which is very effective and commonly used for natural fiber and polymer matrix as the interface. In maleic anhydride grafted polypropylene a part or the whole of propylene (a propylene homopolymer or a propylene/alpha-olefin random copolymer) is graft modified with maleic anhydride in an amount of preferably 10⁻⁸ to 10⁻² g equivalent, more preferably 10⁻⁷ to 10⁻³ g equivalent, based on 1 g of the polypropylene before the graft modification. That is, the modified polypropylene may partly include unmodified polypropylene. When the modified polypropylene for use in the invention contains unmodified polypropylene, the content of the unmodified polypropylene is desired to be not more than 95 parts per weight, usually 85 to 40 parts by weight, based on 100 parts by weight of the total of the graft modified polypropylene and the unmodified polypropylene.

Term, “copolymer polypropylene (COPP)” includes random copolymer polypropylene. A random copolymer that uses ethylene or/and butene-1 in addition to propylene as a monomer to be polymerized. That is, the random copolymer polypropylene may be a random copolymer of propylene and ethylene obtained by copolymerization of propylene with ethylene, a random copolymer of propylene and butene-1 obtained by copolymerization of propylene with butene-1, or a random copolymer of propylene, ethylene and butene-1 by copolymerization of propylene with ethylene and butene-1. Random copolymer polypropylene used in the present invention, commercially available products can be used. Examples of commercially available products include Prime Polypro J-721GR (available from Prime Polymer Co., Ltd.), Prime Polypro J-2021GR (available from Prime Polymer Co., Ltd.), Prime Polypro J-2023GR (available from Prime Polymer Co., Ltd.), Prime Polypro J-2041GA (available from Prime Polymer Co., Ltd.), Prime Polypro J-3021GR (available from Prime Polymer Co., Ltd.), Prime Polypro J226E (available from Prime Polymer Co., Ltd.), Prime Polypro J226T (available from Prime Polymer Co., Ltd.), Prime Polypro J227T (available from Prime Polymer Co., Ltd.), Prime Polypro J229E (available from Prime Polymer Co., Ltd.), Prime Polypro B221WA (available from Prime Polymer Co., Ltd.), Prime Polypro J232WA (available from Prime Polymer Co., Ltd.), Prime Polypro B241 (available from Prime Polymer Co., Ltd.), Prime Polypro F227D (available from Prime Polymer Co., Ltd.), Prime Polypro F219DA (available from Prime Polymer Co., Ltd.). Prime Polypro F329RA (available from Prime Polymer Co., Ltd.), Prime Polypro F-744NP (available from Prime Polymer Co., Ltd.), Prime Polypro F-744NPT (available from Prime Polymer Co., Ltd.), Prime Polypro F-794NV (available from Prime Polymer Co., Ltd.), Novatec EG6D (available from Japan Polypropylene Corporation), Novatec MG3F from (available Japan Polypropylene Corporation), Novatec EG8B (available from Japan Polypropylene Corporation), Novatec EG7F (available from Japan Polypropylene Corporation), Novatec EG7FTB (available from Japan Polypropylene Corporation), Novatec MG03BD (available from Japan Polypropylene Corporation), Sun Allomer PM731M (available from Sun Allomer, Ltd.). Sun Allomer PM731V (available from Sun Allomer, Ltd.), Sun Allomer PM822V (available from Sun Allomer, Ltd.), Sun Allomer PM921M (available from Sun Allomer, Ltd.), Sun Allomer PM731V (available from Sun Allomer, Ltd.), Sun Allomer PM923V (available from Sun Allomer, Ltd.), Sun Allomer PM931M (available from Sun Allomer, Ltd.), Sun Allomer PM931V (available from Sun Allomer, Ltd.), Sun Allomer PM940M (available from Sun Allomer, Ltd.), Sun Allomer PMA20V (available from Sun Allomer, Ltd.), Sun Allomer PB222A (available from Sun Allomer, Ltd.), Sun Allomer PS522M (available from Sun Allomer, Ltd.), Sun Allomer PC540R (available from Sun Allomer, Ltd.), Sun Allomer PC630A (available from Sun Allomer, Ltd.), Sun Allomer PC630S (available from Sun Allomer, Ltd.), Sun Allomer PC741R (available from Sun Allomer. Ltd.), Sun Allomer PF742S (available from Sun Allomer, Ltd.), Sun Allomer PH943B (available from Sun Allomer, Ltd.), and the like.

In an embodiment, COPP comprises about 4 wt. % of ethylene under an isotactic polypropylene domain.

In an embodiment, the COPP has a surface energy increase by about 2 dyne level by a corona treatment.

This invention relates to a highly optically clear, composite film having a thermoplastic polypropylene base layer and an oriented primer layer of a polyurethane composition.

Film of present invention has one or more layers, such as but not limited to core layer, print receptive layer, adhesive receptive layer, barrier layer, adhesive layer, primer layer, coating layer etc. In some embodiments, one or more of the above-mentioned layers may be combined. For example: a coating layer may include primer.

In an embodiment, base layer comprises about 2% to about 4% by weight of the print receptive layer, about 92% to about 96% by weight of the core layer, and about 2% to about 4% by weight of the adhesive receptive layer, wherein all weights are based on a total weight of the base layer.

### Core Layer

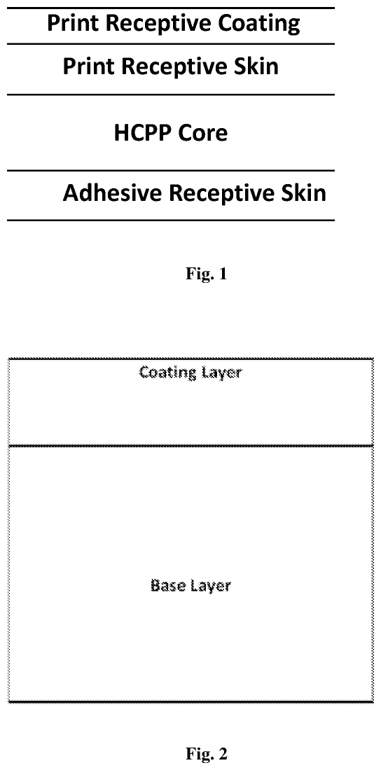

Referring to FIG. 1, the film has a core layer.

In an embodiment, core layer include olefins, such as, for example, polypropylene (PP), for example, biaxially oriented polypropylene (BOPP) (e.g., BEM19 BOPP film, Vifan USA, Inc., Morristown, Tenn.), polyethylene terephthalate (PET), metallized polyethylene terephthalate, low density polyethylene (LDPE), poly(ethylene-co-methacrylic acid) (EMAA) (e.g., Surlyn® films available from DuPont, Wilmington, Del.), or any other suitable material.

Properties of polypropylene depend on the molecular weight and molecular weight distribution, crystallinity, type and proportion of co-monomer (if used) and isotacticity.

In isotactic polypropylene, the methyl groups are oriented on one side of the carbon backbone. This arrangement creates a greater degree of crystallinity and results in a stiffer material that is more resistant to creep than both atactic polypropylene and polyethylene. Perfectly isotactic PP has a melting point of 171° C. (340° F.). Commercial isotactic PP has a melting point that ranges from 160 to 166° C. (320 to 331° F.), depending on atactic material and crystallinity.

In an embodiment, a high crystallinity in a range of about 90-99% isotactic index.

In an embodiment, the core layer has high crystallinity polypropylene.

In the present invention, high crystallinity polypropylene (HCPP) has intermolecular stereoregularity greater than 93%, preferably from 94 to 99%, more preferably from 94 to 98%. Suitable high crystallinity polypropylene (HCPP) resins (film grade) include Amoco 9117 and Amoco 9119, available from Amoco Chemical Co. of Chicago, Ill.; Chisso HF5010 and Chisso XF2805, available from Chisso Chemical Co., Ltd. of Tokyo, Japan. Suitable HCPPs are also available from Solvay in Europe. The high crystallinity polypropylene has a higher intermolecular stereoregularity, that is, an increase in isotactic polymer and decrease in atactic polymer. HCPP exhibits higher crystallinity than conventional polymers resulting in higher stiffness, surface hardness, lower deflection at higher temperatures and better creep properties. Further information relating to HCPP, including methods for preparation of the resin is disclosed in U.S. Pat. No. 5,063,264, incorporated herein by reference.

In an embodiment, the core layer comprised polypropylene. High crystalline PP (HCPP) of Total 3273 is about 94% isotactic index.

In an embodiment, the PP of the core layer is either isotactic or high crystalline PP.

In another embodiment, the core layer comprises an isotactic polypropylene and a crystalline polypropylene.

In an embodiment, core layer comprises one or more biaxially stretched film-forming crystallizable polymers, including polypropylenes and polyesters. The polyesters include polyethylene terephthalate (PET), polyethylene naphthalate, polybutylene terephthalate, polycyclohexyldimethylterephthalate (PCT), etc. Typical polyester resins used in the base layer (B) can include, but are not limited to: homopolyesters or copolyesters of polyethylene terephthalate (PET), polyethylene naphthalate (PEN), polyethylene terephthalate-co-isophthalate copolymer (IPET), polyethylene terephthalate-co-naphthalate copolymer, polycyclohexylene terephthalate, polyethylene-co-cyclohexylene terephthalate, polyether-ester block copolymer, ethylene glycol or terephthalic acid-based polyester homopolymers and copolymers, and combinations thereof. In preferable embodiments, the polyester comprises poly (ethylene terephthalate) repeat units. The polyester in the base layer can comprise about 70-99.9 wt %.

The core layer of the coextruded laminate film can also essentially comprise suitable polyolefins such as crystalline propylene homopolymers and/or high crystalline polypropylene homopolymers (HCPP). Examples of suitable homo-polypropylene resins include Total Petrochemical grades 3271 and 3274, Phillipps 66® CH016 and CH020-01. Examples of suitable high crystalline polypropylene resins (HCPP) include Phillips 66® CH020XK, Total Petrochemical 3270 and 3273. Typically, these polypropylene resins have a melt flow rate in the range of from 1.5 to 4.0 g/10 min., a melting point in the range of from 160-167° C., and a density of about 0.90-0.92 g/cm³. Typically, HCPP resins have xylene solubles less than 3%.

As HCPP is used as the core layer resin, preferably, a desirable amount of hydrogenated hydrocarbon resins can be optionally added into the core layer as a processing aid at an amount of from 1.0 to 25 wt % of the core layer, preferably, 2.5 to 10 wt % of the weight. Examples of suitable hydrogenated hydrocarbon resins include Plastolyn® R1140 and Eastotac® H-142W provided by Eastman Chemicals; Oppera® PR100A provided by ExxonMobil. Typically, these hydrocarbon resins are fully hydrogenated water-white amorphous materials having a softening point of from 130 to 150° C.; a glass transition temperature (Tg) in the range of from 75 to 90° C.; a weight-average molecular weight (Mw) in the range of from 500 to 1000 g/mole.

The core layer resin, whether polyester or polypropylene, is typically 5 μm to 50 μm in thickness after biaxial orientation, preferably between 10 μm and 25 μm, and more preferably between 12 μm and 18 μm in thickness.

### Adhesive Receptive Layer

As shown in FIG. 1, a film has an adhesive receptive layer. Adhesive receptive layer and adhesive receptive skin are interchangeably used.

Adhesive receptive layer is suitable for surface treatment such as flame and corona. This layer is preferably treated in a well-known manner to improve surface adhesion. Adhesive-receptive layer with specific surface properties that ensure a high level of adhesion for the hot melt adhesive and unique properties to prevent the label from curling. Highly functionalized surfaces to avoid the tendency of layers of the reels to stick against themselves and facilitate the unwinding of the reel at high speed.

In an embodiment, the adhesive receptive layer comprises a first component for wettability of a coating adhesive and a second component to form an affinity with the BOPP of the core layer.

In an embodiment, the adhesive receptive layer comprises a copolymer polypropylene (COPP) and homo polypropylene (HOPP).

In an embodiment, COPP could be a random copolymer polypropylene.

In an embodiment, adhesive receptive layer is composed of HOPP (Total Petrochemicals 3272) about 79 wt. % and COPP (Total Petrochemicals 8473) about 21 wt. %.

In an embodiment, adhesive receptive layer is composed of HOPP (Total Petrochemicals 3272) about 79 wt. % and COPP (Total Petrochemicals 8473) about 21 wt. %.

In another embodiment, HOPP may be about 60 wt. %, 65 wt. %, 70 wt. %, 75 wt. %, 80 wt. %, 85 wt. %, and COPP may be about 10 wt. %, 15 wt. %, 20 wt. %, 25 wt. %, 30 wt. %, 35 wt. % or more.

In an embodiment, adhesive printing component comprises maleic anhydride grafted polypropylene (MAH-g-PP).

### Optional Adhesive Layer

Although not shown in FIGS. 1 and 2, an adhesive layer optionally may be applied to the core layer. When the adhesive layer is present, the coating layer is then coated onto the adhesive layer. The adhesive layer may include but is not limited to adhesive materials such as: polyurethanes, polyethyleneimines, acrylics and silanes. Such adhesive layers may be applied using in-line or off-line coating processes.

### Print Receptive Layer

As shown in FIG. 1, a film has a print receptive layer. Print receptive layer and Print receptive skin is interchangeably used.

In an embodiment, print receptive layer has a polyurethane and a cross linker.

In an another embodiment, print receptive layer also has a polyolefin adhesion promoter.

In an another embodiment, print receptive layer has maleic anhydride grafted polypropylene (MAH-g-PP), HOPP, or a copolymer polypropylene (COPP).

### Coating Layer (Also Written as Print Receptive Coating)

As shown in FIGS. 1 and 2, a film has a coating layer.

In an embodiment, coating layer has a polyurethane and a crosslinker.

In an embodiment, a coating layer includes primer.

In an embodiment, coating could be implemented by “off-line” and “in-line” coating methods. The procedures for film stretching and applying the printable layer coating solution distinguish these methods as will be explained.

In polymer morphology, orientation can involve alignment of the structural elements of the polymer, for example, polymer chains, segments of chains and crystallites. Orientation can cause anisotropic physical properties in a polymer product. For a polymer film, orientation can be induced by stretching the film. In most high volume, polymeric film production, the film is formed continuously by extrusion and elongation in which the direction of material flow is commonly known as the “machine direction”. Typically, the first technical direction is the machine direction, and the second technical direction is the cross-machine or “transverse direction” (i.e., in the plane of the film at 90. degree. to the machine direction.

In an embodiment, an off-line process is employed. After applying coating solution, volatile components are removed in a static oven at drying temperatures such that the coating is fully dried and crosslinked and the base layer experiences minimal thermal shrinkage. Care is recommended because the static film can be overheated in the oven such that damage to the composite film can occur, such as undesirable deformation by wrinkling, shrinkage, and the like. To avoid such results, drying temperatures in the static oven of the off-line method should be kept relatively low. For example, temperatures as low as about 75-80° C. might be suitable for drying.

A potential problem of drying at too low a temperature is that the heat energy transmitted to the film is not sufficient to fully activate the crosslinking of the coating to form strong bonds to the film substrate. Thus, to make a composite printable label film with effective bonding by the off-line method, attention must be given to balancing temperature and residence time conditions in the static oven, such as: temperature for drying could be selected as 70° C., 75° C., 80° C., 85° C., etc.; and residence time could be 10 mins, 20 mins, 30 mins, 40 mins, 60 mins, 2 hours, 3 hours, 5 hours, etc.

In an embodiment, in-line production method is used. In this process, the base layer is formed, coated with liquid primer layer solution, and heated to dry and crosslink the polyurethane-comprising coating in a unified and continuous process.

In an embodiment, additional steps can be included, for example the base layer can be uniaxially stretched before coating with liquid solution. Also, the printable coating layer can be dried, crosslinked, and stretched at the same time or in rapid succession after coating, for example, during the second orientation process step in a biaxially oriented film composition.

Furthermore, in an embodiment, the composite printable label film can be heat-treated to anneal the film after the printable coating layer is formed.

A major advantage of the in-line method is that time and temperature of heat exposure during solution drying can be controlled very well. This permits higher temperatures to be used for appropriately short residence times. Consequently, the printable label layer solution can be dried with effectively complete crosslinking of the polyurethane (PUR) components and/or acrylic components with reduced risk of damaging the film. Also, in the in-line process, drying and crosslinking can be accomplished at or very near the same time as stretching the base layer in at least one direction. It has been found that such contemporaneous drying, crosslinking, and stretching of acrylics can be significantly detrimental to ink adhesion.

In an embodiment, in-line process includes the continuous, sequential steps of (a) forming a polymer core base layer; (b) optionally adding an adhesive layer and/or a skin layer to make the base layer, typically via coextrusion with the core base layer; (c) stretching the base layer, preferably uniaxially in the machine direction, (d) coating the base layer with a liquid solution of printable receptive coating and crosslinker; (e) heating the coated base layer effectively to dry and crosslink the printable label PUR components; and, (f) optionally stretching the composite printable label PUR primer layer in the transverse direction during or immediately following the drying and crosslinking step; and (g) optionally heat-treating to anneal the composite printable label film to reduce thermal stresses within the polymeric composite film from any orientation process steps. When present as a component of the base layer, step (d) coating is applied to the surface of the adhesive layer.

In an embodiment, in-line method includes extruding a sheet of polymer from granulated solid form such as pellets in a melt processing apparatus. Continuously following extrusion, the sheet is stretched in the first technical direction, usually the machine direction. The solution coating apparatus is positioned directly after the base layer is formed and uniaxially stretched. Liquid coating solution is applied while the uniaxially oriented base layer moves continuously through the coating apparatus application station. The same solution coating technologies described above for off-line coating may be used for placing the wet coat of print priming layer solution on the polymer base layer. For the in-line method, reverse gravure roll coating techniques are preferred.

Directly and continuously following liquid solution coating of the base layer, drying, crosslinking and preferably a second biaxial stretching steps are performed in rapid succession. In-line fabrication can use the same composite barrier film finishing methods as described for “off-line”, but instead of using a static oven, the film is continuously fed through a tenter frame stretching oven, typically used for the second, transverse orientation step. The tenter frame stretching oven has several heating zones so that different segments of the process can be at temperatures tailored to accomplish each unit function. For example, the wet-coating volatiles can be substantially completely removed to form a dry unitary barrier layer adhered to the substrate surface in the preheating and drying heat oven zones.

Then temperature can be adjusted to a range adapted to activating crosslinking of the polyurethane components and to stretching of the composite label film. Preferably the coating layer is fully dried before crosslinking and stretching. In a nominal 1.5 m wide tenter frame stretching oven, typical crosslinking and biaxial stretching zone temperatures of the in-line method are in the range of 155-160° C. for polypropylene base layer film. In an embodiment, typical crosslinking and biaxial stretching zone temperatures of the in-line method could vary from 100° C., 120° C., 140° C., 150° C., 180° C., 200° C., 250° C. or more, depending on the type of base layer film.

These operating temperatures are much higher than should be used in the off-line method. Higher temperature can be tolerated during in-line processing because the flow of film is continuous through the heat zones and time and temperature exposure can be controlled to avoid damaging the film. In another embodiment, some or all of the liquid solvent removal occurs, and the label coating is crosslinked with a melamine and/or a carbodiimide crosslinking agent during oven heating while conducting transverse stretching. After transverse stretching, the film can be heat-set to minimize shrinkage.

It has been discovered that the crosslinked printable coating layer can be stretched to large transverse extensions while remaining intact and maintaining excellent adhesion properties over the full surface of the multilayer film. This performance is predominantly observed when the wet coating solution is applied to an already uniaxially stretched base layer, and the printable label coating layer is contemporaneously dried, crosslinked and biaxially stretched-this can occur in the carbodiimide and/or melamine crosslinked printable label polymer layer.

In an embodiment, a printable label coating layer has been found to successfully extend to about 3.0-4.5 times its original transverse dimension, and even 3.0 times-10.0 times, which is a property suitable for orientable substrate materials such as polypropylene. In an embodiment, a printable label coating layer can extend about 2 times, 3 times, 4 times, 5 times, 6 times, 7 times, 8 times, 9 times, 10 times, 11 times, 12 times, 13 times, 14 times, 15 times or more its original transverse dimension.

In an embodiment, a coating layer is applied to the base layer from a solution comprising of polyurethane and is crosslinked using a crosslinking agent such as (but not limited to): carbodiimide, melamine, aziridine etc.

In some embodiments, coating may include acrylic along with polyurethane. In some embodiments, coating is free of acrylic. Acrylic is a water-soluble acrylic.

Polyurethane is a water-soluble polyurethane.

In an embodiment, liquid dispersion of coating typically contains 70% to 2% by weight, preferably 65% to 94% by weight polyurethane based on the total weight of the liquid dispersion. In an embodiment, polyurethane is in a value varying from 2%, 4%, 10%, 15%, 20%, 25%, 30%, 35%, 40%, 45%, 50%, 60% or 70% by weight based on the total weight of the liquid dispersion.

polyurethane dispersion is about 2 pph, 5 pph, 10 pph, 20 pph, 30 pph, 40 pph, 50 pph, 60 pph, or 70 pph of the coating.

In an embodiment, cross-linker is about 0.5 pph, 1 pph, 1.5 pph, 2 pph of the coating. In an embodiment, cross-linker is in a value varying from 0.5%, 1%, 1.5%, 2%, 2.5%, by weight based on the total weight of the liquid dispersion.

In an embodiment, thickness of coating layer is about 0.10 GSM, 0.12 GSM, 0.16 GSM, 0.20 GSM, 0.25 GSM, 0.50 GSM. In an embodiment, thickness of coating is in range of about 0.1 GSM to about 0.25 GSM. GSM=um (micron)=10, 000 Angstroms

In an In an embodiment, primer coated base layer composite can be printed upon by using various techniques such as ink-jet printing using various ink types such as: waterborne, UV-curable, and solvent borne inks.

This invention will be better understood with reference to the following examples, which are intended to illustrate specific embodiments within the overall scope of the invention.

### Test Methods

### Haze

Haze of the films was measured according to ASTM D1003 that determines the percent of transmitted light scattered at more than 2.5° from the incident light. A suitable instrument to measure haze is GARDNER HAZE-GUARD PLUS #475. A haze change of 3% or less was considered acceptable, and 2% or less is preferred.

### Ink Receptivity Test Based on 10 Pull Protocol

Testing Procedure for Ink Adhesion Testing: Adhere the test film sample, with the primer coating side upwards, onto a cardboard Luneta card (Dimensions: 10¼ in×5⅝ in). Acquire a hand proofer with a rubber flexo-roller. Apply a small bead of ink near the top of the primed film. Use the hand proofer to distribute a manageable amount of ink over the Leneta card.

Procedure for curing different ink types: Solvent Ink (Standard ink: Morris Solvent Borne) and waterborne (standard ink Flint Black) With the ink just applied, allow for at least 30-60 seconds for the solvent to evaporate in the hood. Place the ink primed film sheet into a lab oven set to 85° C., allowing the samples to dry for at least 45 seconds. Samples are now ready for tape testing.

UV Curable Ink (Standard ink: Sun Chemical UV Yellow): Apply UV inks onto primed film substrate, turn on the conveyor belt to the curing system, followed by turning on the lamp (Curing lamp should be set to 400 W/m\hat{ }2) Place the samples one at a time onto the belt. Once all the samples have been cured, they are ready for ink adhesion testing.

Procedure for testing ink receptivity [10 Pull Protocol (Most aggressive test)]: Create a crosshatch style scratch in the ink by using the Gardco cross hatch adhesion tester. Starting with the Scotch 600 tape type, adhere, and pull the tape from the surface of the inked sample. The pull should be done such that the tape is pulled in the direction it was applied. The tape is not meant to be gently removed in reverse from the direction it was applied. If the percentage removed is less than 95%, proceed with an additional tape pull with a new piece of tape. Proceed to perform step 3 repeatedly until 95% or more of the ink is removed, or when 10 tape pulls are performed. Record either the number of pulls performed (until 95% or more ink was removed), or the percent ink removed (after 10 tape pulls). On the same sample, perform the test in a different area with the Scotch 810 tape type, or other tapes of interest.

For Scotch 600 and 810 an acceptable rating is 1-2, 3-5 are unacceptable.

Table 1 below provides ink rating classification.

TABLE 1
Ink Rating classification
Removal rating: 1-5, Good to Bad

| Ink Removed (%) | Rating (1-5) |
|---|---|
| 0-10 | 1 |
| 10.1-30 | 2 |
| 30.1-60 | 3 |
| 60.1-90 | 4 |
| >90.1 | 5 |

### Boil Testing

Ink receptive coating adhesion test (Boil Test): A 12.7 cm×25.4 cm sample of film coated with print receptive coating, was submerged in boiling water (100° C.) for 10 minutes. Thereafter the surface of the film was visually inspected and rated according to the scale below.
Rating 1 (Good): No discoloration, no coating transfer or delamination occurs.
Rating 2 (Acceptable): Discoloration occurs.
Rating 3 (Unacceptable): Discoloration and coating transfer or delamination occur.

### Acrylic Material (Hard Coat) Adhesion Test (Tape Test)

A 12.7 cm×25.4 cm sample of film coated with a print receptive primer is securely adhered with 3M Scotch® Brand 810 tape. Then, the tape is peeled off rapidly by hand in the vertical and horizontal direction and observed for transfer of the hard coat layer and provided a pass/fail rating.

### EXAMPLES

Examples of the invention: The liquid mixtures were formed by combining and blending to uniform compositions as shown in Table 2 in parts weight per hundred (“pph”) of an acrylic/polyurethane and polyurethane dispersions.

Example 1: The acrylic dispersion was 22.6 parts (Neocryl® BT67 produced by Covestro, Inc.). 22.6 parts of a polyurethane dispersion (Neorez® R605, Covestro, Inc.). 0.11 parts of an acid catalyst (Nacure® 5925, produced by King industries). 0.1 parts of a coalescing agent (Butyl Cellosolve, produced by 1.16 parts of a melamine crosslinker (Cymel® 303LF, produced by Allnex Corporation),1.15 parts of a carbodiimide crosslinker (Carbodilite® VO2L2, produced by Nisshinbo Chemical Inc).

Example 2: The acrylic dispersion was 39.91 parts (Neocryl® BT67, Covestro). 4.44 parts of polyurethane (Neorez® R605, Covestro). The silica particle dispersion was a 20 wt % aqueous dispersion at 0.46 parts of synthetic amorphous silica particles (Nalco® 2329—who supplies it?). 0.99 parts of adhesion promotor (Advantis® 510 W, produced by Eastman Chemical Co.), 0.12 parts of an acid catalyst (Nacure® 5925, King industries), 0.1 parts of a coalescing agent (Butyl Cellosolve, produced by Dow Chemical Company® 0.27 parts of a melamine crosslinker (Cymel® 303LF, Allnex Corporation), 1.87 parts of a carbodiimide crosslinker (Carbodilite® VO2L2, Nisshinbo Chemical Inc).

Example 3: 57.49 parts of polyurethane (Neorez® R670, Covestro). The silica particle dispersion was a 20 wt % aqueous dispersion at 0.6 parts of synthetic amorphous silica particles (Nalco® 2329, Nalco® Company), 1.44 parts of a carbodiimide crosslinker (Carbodilite® SVO2, Nisshinbo Chemical Inc).

Example 4: 49.3 parts of a polyurethane dispersion (Neorez® R605, Covestro). The silica particle dispersion was a 20 wt % aqueous dispersion at 0.51 parts of synthetic amorphous silica particles (Nalco® 2329, Nalco® Company), 4.17 parts of adhesion promotor (Advantis® 510 W, Eastman Chemical Co.), 1.23 parts of a carbodiimide crosslinker (Carbodilite® SVO2, Nisshinbo Chemical Inc).

Example 5: 49.3 parts of a polyurethane dispersion (Neorez® R605, Covestro). The silica particle dispersion was a 20 wt % aqueous dispersion at 0.50 parts of synthetic amorphous silica particles (Nalco® 2329, Nalco® Company), 4.20 parts of adhesion promotor (Advantis® 510 W, Eastman Chemical Co.), 1.20 parts of a carbodiimide crosslinker (Carbodilite® VO2L2, Nisshinbo Chemical Inc).

Example 6: 52.9 parts of a polyurethane dispersion (Neorez® R605, Covestro). 2.2 parts of a coalescing agent (Butyl Cellosolve, Dow® Chemical Company 1.40 parts of a carbodiimide crosslinker (Carbodilite® SVO2, Nisshinbo Chemical Inc).

TABLE 2
Formulations in different examples

| | Example 1 | | Example 2 | | Example 3 | | Example 4 | | Example 5 | | Example 6 | |
|---|---|---|---|---|---|---|---|---|---|---|---|---|
| Formulation | | Solids | | Solids | | Solids | | Solids | | Solids | | Solids |
| Information | pph | Fraction | pph | Fraction | pph | Fraction | pph | Fraction | pph | Fraction | pph | Fraction |
| Dry Primer | 0.16 um (micron) | | 0.16 um | | 0.16 um | | 0.16 um | | 0.16 um | | 0.16 um | |
| Thickness: | | | | | | | | | | | | |
| Waterborne | 22.60 | 8.81 | 39.91 | 15.56 | | | | | | | | |
| Acrylic | | | | | | | | | | | | |
| Waterborne | | | | | 57.49 | 17.25 | | | | | | |
| Polyurethane | | | | | | | | | | | | |
| Waterborne | 22.60 | 7.46 | 4.44 | 1.46 | | | 49.30 | 16.27 | 49.30 | 16.27 | 52.85 | 17.44 |
| Polyurethane | | | | | | | | | | | | |
| Water | 52.27 | | 50.84 | | 40.48 | | 44.79 | 0.00 | 44.79 | | 43.60 | |
| Antiblock | | | 0.46 | 0.14 | 0.60 | 0.18 | 0.51 | 0.15 | 0.51 | 0.15 | | |
| Adhesion | | | 0.99 | 0.24 | | | 4.17 | 1.00 | 4.17 | 1.00 | | |
| Promoter | | | | | | | | | | | | |
| Melamine | 0.11 | 0.03 | 0.12 | 0.03 | | | | | | | | |
| Acid Catalyst | | | | | | | | | | | | |
| Coalescing | 0.10 | | 1.11 | 0.00 | | | | | | | 2.15 | |
| Agent | | | | | | | | | | | | |
| Melamine | 1.16 | 1.14 | 0.27 | 0.26 | | | | | | | | |
| Crosslinker | | | | | | | | | | | | |
| Carbodiimide | | | | | 1.44 | 0.57 | 1.23 | 0.49 | | | | |
| Crosslinker #1 | | | | | | | | | | | | |
| Carbodiimide | 1.15 | 0.46 | 1.87 | 0.75 | | | | | 1.23 | 0.49 | 1.40 | 0.56 |
| Crosslinker #2 | | | | | | | | | | | | |
| Total: | 100.00 | 17.90 | 100.00 | 18.45 | 100.00 | 18.00 | 100.00 | 17.92 | 100.00 | 17.92 | 100.00 | 18.00 |

### Results

Table 3 and 4 provide results of each example tested according to provided test methods.

TABLE 3
Ink Adhesion Results using Scotch ® 600 and 810 tape.

| | | | acrylic/urethane | | polyurethane blends | | | |
|---|---|---|---|---|---|---|---|---|
| | | | Ex. 1 | Ex. 2 | Ex. 3 | Ex. 4 | Ex. 5 | Ex. 6 |
| Base film Haze: | | | 0.92 | 0.92 | 0.92 | 0.92 | 0.92 | 3.50 |
| Haze: | | | 6.87 | 3.93 | 6.36 | 1.47 | 1.60 | 2.90 |
| | Ink Type: | Tape Type: | | | | | | |
| Ink | Red | Scotch 600 | 50% | 35% | 30% | 20% | 20% | 5% |
| Adhesion | Solvent | Scotch 810 | 50% | 25% | 25% | 85% | 40% | 5% |
| Testing | Ink | | | | | | | |
| | UV Ink: | Scotch 600 | 90% | 45% | 40% | 45% | 45% | 15% |
| | Yellow | Scotch 810 | 70% | 35% | 45% | 10% | 10% | 10% |

Each coating example was applied to the polypropylene base film using the in-line coating process as described. Table 3 results illustrate the ink adhesion improvement of polyurethane primers versus acrylic urethane primers.

Table 4 provides comparison of in-line vs off-line Boiling test.

TABLE 4
In-line vs. Off-line Boiling test

| | | Haze value | | | | 810 |
|---|---|---|---|---|---|---|
| | | initial | 10 | Degree | Evaluation | tape |
| Boil testing Results | | haze | min | difference | rating | testing |
| 1) Offline | Example 1 | 6.87 | 76.70 | 69.83 | 4 | fail |
| coating | Example 2 | 3.93 | 81.50 | 77.57 | 3 | pass |
| application | Example 3 | 2.24 | 10.00 | 7.76 | 2 | pass |
| | Example 4 | 2.30 | 11.00 | 8.7 | 2 | pass |
| | Example 5 | 2.24 | 10.60 | 8.36 | 2 | pass |
| | Example 6 | 2.24 | 9.00 | 6.76 | 2 | pass |
| 2) inline | Example 1 | 6.87 | 8.50 | 1.63 | 1 | pass |
| coating | Example 2 | 3.93 | 6.00 | 2.07 | 1 | pass |
| application | Example 3 | 6.36 | 6.90 | 0.54 | 1 | pass |
| | Example 4 | 1.47 | 2.30 | 0.83 | 1 | pass |
| | Example 5 | 1.60 | 4.55 | 2.95 | 1 | pass |
| | Example 6 | 2.90 | 3.50 | 0.60 | 1 | pass |

In-line coated print primer samples outperform the off-line coated samples with a haze degree difference below 3%.

In an embodiment, polyurethane primer not only withstands the boil process, but it can also withstand the 10× orientation with improved ink adhesion vs acrylic coatings (which tend to crack and/or lose ink adhesion.)

### Incorporation by Reference

The entire disclosure of the patents and publications referred to in this application are hereby incorporated herein by reference in their entirety.

1. A film comprising a base layer comprising a biaxially oriented polypropylene (BOPP) or Polyester film and an in-line primer coating layer comprising a polyurethane and a crosslinker; wherein the film has a haze change before exposure to boiling water for 10 minutes and after exposure to boiling water for 10 minutes 3% or less, measured according to ASTM D1003, wherein the in-line primer coating layer is substantially free of an acrylic coating material.

2. The film of claim 1, wherein the crosslinker comprises carbodiimide and/or melamine.

3. (canceled)

4. The film of claim 1, wherein thickness of the in-line primer coating layer is in range of about 0.1 microns to about 2.5 microns.

5. The film of claim 1, wherein the in-line primer coating layer further comprises an adhesion promoter.

6. (canceled)

7. The film of claim 1, wherein the in-line primer coating layer comprises a crosslinker catalyst.

8. The film of claim 1, wherein the base layer comprises a print receptive layer, a core layer, and an adhesive receptive layer.

9. The film of claim 8, wherein the core layer comprises polypropylene.

10. The film of claim 9, wherein the polypropylene has crystallinity in a range of about 90-99% isotactic index.

11. The film of claim 9, wherein a print primer receptive layer comprises a first component for wettability of a coating print primer and a second component to form an affinity with the polypropylene of the core layer.

12. The film of claim 11, the first component and the second component are same.

13. The film of claim 12, the first component comprises MAH-g-PP.

14. The film of claim 1, wherein the film further comprises a primer receptive layer comprising maleic anhydride and a polyolefin.

15. The film of claim 8, wherein an adhesive layer is between the in-liner primer coating layer and a core layer, wherein the adhesive layer comprises maleic anhydride and a polyolefin.

16. (canceled)

17. The film of claim 8, wherein the print receptive layer comprises maleic anhydride grafted polypropylene (MAH-g-PP), HOPP, or a copolymer polypropylene (COPP).

18. The film of claim 8, wherein the core layer comprises an isotactic polypropylene and a crystalline polypropylene.

19. The film of claim 18, wherein the crystalline polypropylene comprises about 94% isotactic index or more.

20. The film of claim 8, wherein the adhesive receptive layer comprises a copolymer polypropylene (COPP) and HOPP.

21. The film of claim 20, wherein the COPP comprises about 4 wt % by of ethylene under an isotactic polypropylene domain.

22. (canceled)

23. The film of claim 8, wherein the base layer comprises about 2% to about 4% by weight of the print receptive layer, about 92% to about 96% by weight of the core layer, and about 2% to about 4% by weight of the adhesive receptive layer, wherein all weights are based on a total weight of the base layer.

24. The film of claim 1, wherein the substantially free acrylic coating material comprises less than 5% of the acrylic coating material.
